(19) United States
(12) Patent Application Publication
(10) Pub. No.: US 2026/0355925 A1
(43) Pub. Date: Nov. 12, 2026

(54) Protective Device, Accumulator Protection Element, Portable Working Device and Method at Least for Protecting an Accumulator

(71) Applicant: Robert Bosch GmbH, Stuttgart (DE)

(72) Inventors: Tobias Fischer, Leinfelden-Echterdingen (DE); Fabian Schempp, Stuttgart (DE); Kevin Doll, Winterbach (DE)

(21) Appl. No.: 19/129,762

(22) PCT Filed: Oct. 30, 2023
(86) PCT No.: PCT/EP2023/080175

§ 371 Date: May 14, 2025

(30) Foreign Application Priority Data
Nov. 15, 2022 (DE) 10 2022 212 097.3

(51) Int. Cl. B25F 5/02; H01M 50/242; H01M 50/247

(52) U.S. Cl. CPC B25F 5/02; H01M 50/242; H01M 50/247; H01M 2220/30

(57) ABSTRACT

An impact protection device for a portable working device includes at least one accumulator protection unit that is different from a working device housing, and which is configured to protect at least one accumulator of the working device from impact damage, such as impact damage from an impact due to the working device falling, by at least partially at least laterally surrounding an accumulator mounting region.

### PRIOR ART

Due to the fire hazard posed by damaged accumulators, especially lithium-ion accumulators, protecting accumulators in everyday use is becoming increasingly important.

### DISCLOSURE OF THE INVENTION

A protective device, in particular an impact protection device, is proposed for a portable working device, with at least one accumulator protection unit designed differently from a working device housing, which is designed to protect at least one accumulator of the working device from damage, in particular impact damage, for example due to an impact resulting from the working device falling, by at least partially surrounding at least the sides of a accumulator mounting region.

The protective device's design according to the invention has the advantage of increasing operational safety, as it prevents damage to the accumulator that the protective device is designed to protect. It is advantageous to extend the maintenance interval and/or cleaning interval, since the lateral enclosure of the accumulator mounting region drastically reduces contamination of the electrical contact regions and/or the accumulator mounting region intended for accumulator mounting region, for example by dust or splashing liquids. This has the advantage of increasing safety for the user, as it prevents damage to the accumulator that could, for example, cause the accumulator to catch fire or release substances from inside the accumulator that are hazardous to the user. For example, it is known that even slight damage to an accumulator that may go unnoticed, e.g. due to a fall, can cause the accumulator to heat up slowly over several hours and ultimately lead to an accumulator fire, e.g. if the working device with the accumulator is already stored in a vehicle or building. This and the associated potentially catastrophic effects can be advantageously avoided by the protective device. In particular, the protective device is designed to reliably protect the accumulator from falls from heights of at least 50 cm, preferably at least 1 m, and particularly preferably at least two meters.

Preferably, the accumulator is assigned to at least one portable working device. For example, the accumulator can be designed as a replaceable battery pack that can be mounted on one or more, in particular different, portable working devices. The working device is ideally designed to be operated manually by a user, at least for the most part. The working device is preferably designed as a portable and/or mobile working device. The working device is preferably designed as a handheld power tool and/or a gardening tool and/or a household appliance and/or a hygiene device and/or a comparable device, which is intended to be operated with an accumulator. For example, the portable and/or mobile handheld power tool may be a pipe wrench, a pipe press, a cordless screwdriver, an electric saw, e.g. a jigsaw, a drill, a grinding machine, a sheet metal shears, a milling machine, a hot glue gun, a blower, a multifunctional tool, a polishing machine, a planing machine or a comparable handheld power tool. For example, the portable and/or mobile gardening tool can be designed as a hand mower, hedge trimmer, lawn trimmer, tree saw, leaf blower, chainsaw, scarifier, electric pruning shears, pole pruner, electric gardening hoe, electric brush, or a similar gardening tool. For example, the portable and/or mobile household appliance may be designed as a cleaning device, such as a vacuum cleaner, a window vacuum cleaner, a high-pressure cleaner, as a personal care device, such as a shaver, a hair dryer, an electric toothbrush, as a lighting device, such as a flashlight, or a comparable household appliance. In addition, embodiment as another accumulator-powered portable working device from a different field of application, e.g., medicine, is also conceivable. The protective device is preferably arranged and/or fixed to the portable and/or mobile working device. It is also conceivable that the protective device protects an accumulator on a non-portable working device that could, for example, tip over. “Portable” refers to a working device that is so light that it can be transported by an adult operator without aids, in particular by carrying and/or rolling and/or pushing, and that the operation of the working device is at least largely manual.

Preferably, the protective device is at least designed to protect the accumulator and/or the working device housing from the working device. The protective device is preferably designed as an impact protection device which serves as protection against impact and/or contamination, in particular by dust and/or dirty water, and/or against scratching of the components to be protected. It is conceivable that the protective device protects other components of the working device, such as a working device drive and/or a control element of the working device and/or a display or other elements, from damage. The protective device is preferably designed as a single piece or two pieces. The protective device preferably has a U-shaped design. The fact that an object is intended, designed, or configured for a specific function should preferably be understood to mean that the object fulfills and/or performs this specific function in at least one application and/or operating state.

Preferably, the accumulator protection unit is arranged at least partially in close proximity to the accumulator. In particular, the close proximity to the accumulator is formed by all points that are at a distance of less than 30 cm, preferably 15 cm, advantageously 10 cm, and preferably 5 cm from the accumulator. Preferably, the accumulator protection unit is arranged at least largely parallel to an accumulator mounting direction and laterally adjacent to the accumulator to be protected. The accumulator protection unit is preferably designed to protect an accumulator of the working device from impact loads. Preferably, the accumulator protection unit protects not only the accumulator but also an electrical accumulator interface, which is designed in particular for energy transfer from the accumulator to the working device, in particular to a drive of the working device and/or to a measuring unit of the working device and/or to a control and regulation unit of the working device, and/or to an output unit or other electrically operated functional units of the working device.

A “shock” is understood to mean, in particular, the transfer of force through at least brief contact between two solid bodies. The impact is preferably caused by a collision resulting from the working device falling onto a solid object, such as the ground, and/or the working device striking a solid object, such as a wall, and/or a solid object striking the stationary working device, such as a stone falling onto the parked working device.

An “accumulator interface” refers in particular to a contact region designed to transfer electrical energy from the accumulator to the working device. In addition to electrical energy transfer, the accumulator interface could also be designed to transfer information such as accumulator temperature and/or electrochemical health status of the accumulator and/or accumulator charge level and/or other data, in particular measurement data, via a data interface such as a USB interface or BUS system and/or a comparable interface.

“Damage” is to be understood in particular as a preferably mechanical change to a component which leads to an impairment of a function and/or a performance and/or a service life and/or a visual appearance of the component.

The accumulator is preferably designed as an energy storage device, in particular an electrochemical energy storage device, which is intended to absorb electrical energy during a charging process and to deliver the electrical energy to a consumer of the working device during operation. In particular, the accumulator is designed as a Li-ion accumulator. It is conceivable that the accumulator is also designed as a disposable accumulator, such as a battery. The accumulator is preferably removable and/or replaceable on the working device. However, it is conceivable that the accumulator is permanently integrated into the working device. The term “accumulator mounting region” refers in particular to a region that is filled by the fully mounted accumulator. The accumulator preferably has an accumulator mounting direction. The accumulator should preferably only be mounted in the accumulator mounting direction. The term “accumulator mounting direction” refers in particular to the direction in which the accumulator is intended to be inserted into the designated accumulator mounting region.

The working device housing is preferably designed to protect the components in the working device housing, in particular from dirt and/or damage. The working device housing is preferably designed to protect the user from injury, in particular from rotating and/or live and/or hot components. The working device housing is preferably designed to enable the user to grip and/or hold and/or use the working device. In particular, the accumulator protection unit and/or the accumulator mounting region can be arranged at any location on the working device housing. The accumulator protection unit and/or the accumulator mounting region are preferably located at a lower end of the working device housing. Preferably, the accumulator protection unit and/or the accumulator mounting region is located in close proximity to a handle of the portable working device. In particular, the close proximity to the handle of the portable working device is formed by all points that are at a distance of less than 30 cm, preferably 15 cm, advantageously 10 cm, and preferably 5 cm from the accumulator. In particular, the accumulator protection unit is designed separately from the working device housing. In particular, the accumulator protection unit is mounted on the working device housing.

The accumulator protection unit is preferably designed to protect the accumulator from impact and/or contamination, in particular from dust and/or dirty water, and/or from scratching. The accumulator protection unit is preferably located in the close proximity the accumulator to be protected. In particular, the close proximity to the accumulator is formed by all points that are at a distance of less than 30 cm, preferably 15 cm, advantageously 10 cm, and preferably 5 cm from the accumulator.

It is also proposed that the accumulator protection unit, in particular a first accumulator protection element and a second accumulator protection element of the accumulator protection unit, at least in a connection region of the accumulator protection unit in which the accumulator protection unit is connected to the working device, surrounds the working device housing, in particular a part of the handle of the working device housing, at least to a large extent, preferably completely, circumferentially. A particularly stable connection can be formed, which is advantageous because the component load on the connection between the accumulator protection unit and the working device housing is reduced when force is applied, especially as a result of an impact, since the force is distributed particularly well over the entire circumference of the surrounding connection. Preferably, the first accumulator protection element and the second accumulator protection element touch the working device housing at least substantially circumferentially. Preferably, the second accumulator protection element is designed to be mirror-symmetrical to the first accumulator protection element. Preferably, the contact region at least of the first accumulator protection element and the second accumulator protection element with the working device housing forms the connection region of the accumulator protection unit. Preferably, the accumulator protection unit forms an insertion region for inserting the accumulator, in particular aligned to the side of the working device. Preferably, the walls of the accumulator protection unit are lowered in the insertion region, in particular flush with the working device housing and/or an accumulator mounting unit of the protective device. The connection region is preferably designed to connect the accumulator protection unit to the working device housing. Preferably, the connection region is additionally designed to protect a region of the working device housing facing the accumulator from damage. The connection region is preferably located in close proximity to the electrical accumulator interface and/or the connection region. In particular, the close proximity to the accumulator interface is formed by all points that are located at a distance of less than 30 cm, preferably 15 cm, advantageously 10 cm, and preferably 5 cm from the accumulator interface. In this context, “a large proportion” should be understood to mean 60%, preferably 70%, 80% or, ideally, 90%.

It is further proposed that the accumulator protection unit comprises at least the first accumulator protection element and at least the second accumulator protection element, which is formed separately from the first accumulator protection element. Repair costs can be reduced, since, particularly in the event of an impact, only the first accumulator protection element and/or the second accumulator protection element is damaged, meaning that only the first accumulator protection element and/or the second accumulator protection element needs to be replaced and, particularly advantageously, not the working device housing. Preferably, the first accumulator protection element and the second accumulator protection element are arranged on two different sides opposite the mounted accumulator. Preferably, the first accumulator protection element contacts the second accumulator protection element in the mounted state in at least one contact region and preferably in at least two contact areas, in particular in contact regions arranged separately from one another. Preferably, the two contact regions are arranged separately from each other on two different sides opposite the mounted accumulator. Preferably, the first accumulator protection element and the second accumulator protection element completely form the accumulator protection unit. Preferably, the first accumulator protection element and/or the second accumulator protection element are made of an impact-resistant and/or energy-absorbing material, such as a plastic or a composite material or a metallic material. The mounted accumulator protection unit should preferably be completely open at an end region facing away from the working device housing.

In addition, it is proposed that the first accumulator protection element forms at least one, in particular full-surface, first accumulator protection jaw and/or that the second accumulator protection element forms a, in particular full-surface, second accumulator protection jaw. Protection of the accumulator against damage and/or contamination can be achieved, since the full-surface first accumulator protection jaw and the full-surface second accumulator protection jaw in particular have a dirt-repellent and/or dirt-and water-repellent effect due to their closed design. It is advantageous that repairs can be carried out by the user themselves, as the first accumulator protection element and/or the second accumulator protection element in particular can be replaced very easily. Preferably, at least the first, in particular the full-surface, accumulator protection jaw and/or at least the second, in particular the full-surface, accumulator protection jaw is designed to shield and/or divert dirt and/or dirty water from the accumulator. Preferably, at least the second accumulator protection jaw is aligned at least substantially parallel to the first accumulator protection jaw. Preferably, the first accumulator protection element, in particular the first accumulator protection jaw, and the second accumulator protection element, in particular the second accumulator protection jaw, are arranged mirrored to each other. The first accumulator protection jaw and the second accumulator protection jaw are preferably arranged on opposite sides of the accumulator. Preferably, the first accumulator protection jaw and the second accumulator protection jaw are arranged on two longitudinal sides, in particular on the longest side surfaces, of the accumulator. Preferably, the accumulator protection jaws are arranged so that they do not touch and/or come into contact with the accumulator. Preferably, the first accumulator protection jaw and/or the second accumulator protection jaw protrude in the main impact direction and/or in the mounting direction. Preferably, the first accumulator protection jaw and the second accumulator protection jaw are connected to each other via the first accumulator protection element and the second accumulator protection element and the connecting element and, in particular, are designed free of further connecting elements and/or webs. In particular, the accumulator protection elements are free of connecting webs at least on one side facing away from the accumulator mounting region. The accumulator protection unit should preferably be open on the side facing away from the accumulator mounting region, preferably completely open. Preferably, at least the first accumulator protection jaw and/or at least the second accumulator protection jaw are made of plastic, in particular injection-molded plastic. The plastic material should preferably have a lower strength than the material of the working device housing. It is conceivable that at least the first accumulator protection jaw and/or at least the second accumulator protection jaw are made of a composite material with improved material properties in terms of material strength and/or material elasticity. It is possible that the accumulator protection jaws may have perforations, such as small holes and/or slits.

It is also proposed that the first accumulator protection jaw and/or the second accumulator protection jaw have a main extension plane which is at least substantially parallel to a most probable main impact direction and/or at least substantially perpendicular to an accumulator mounting direction. It is advantageous to improve the strength of the first accumulator protection jaw and the second accumulator protection jaw, since rigidity is increased in particular by the parallel arrangement of a longest surface of the accumulator protection jaw. The “most probable main impact direction” refers in particular to a force direction induced by an impact between two solid bodies, which occurs most frequently in the event of multiple impacts.

In the event of a fall, the main direction of impact is primarily influenced by the position in which the working device hits the ground. Initial contact is most likely to occur with a surface of a component that is closest to the mounted accumulator, since the mounted accumulator is, at least in most cases, closest to the center of gravity of the working device. The “main extension plane” of a building unit is understood to mean, in particular, a plane that is parallel to the largest side surface of the smallest imaginary cuboid that completely encloses the building unit and, in particular, passes through the center of the cuboid.

It is further proposed that the first accumulator protection element and the second accumulator protection element are connected to each other by at least one detachable connecting element, for example a screw. Repair costs can be reduced, since, particularly in the event of an impact, only the first accumulator protection element and/or the second accumulator protection element is damaged, meaning that only the first accumulator protection element and/or the second accumulator protection element needs to be replaced and, particularly advantageously, not the working device housing. In certain designs, this could have the advantage of enabling repairs to be carried out by the user themselves. This has the advantage of improving the strength of the working device housing, since the working device housing does not have to be weakened by a hole for a screw connection. Preferably, the detachable connecting element is arranged in close proximity to the connection region with the working device. In particular, the close proximity to the connection region is formed by all points that are less than 20 cm, preferably 10 cm, advantageously 5 cm, and preferably 2 cm away from the connection region. Preferably, the connecting element, in particular a main direction of extension of the connecting element, is arranged parallel to a nearest side surface of the working device housing. A “connecting element” is understood to mean, in particular, at least one component that connects two separately formed parts to each other in a form-fitting and/or force-fitting manner. The “main direction of extension” of an object refers in particular to a direction that runs parallel to the longest edge of the smallest geometric parallelepiped that completely encloses the object.

Furthermore, it is proposed that, in one possible embodiment, the accumulator protection unit is connected to the working device housing without screw connections, preferably in a manner that can be separated without damage. Repair costs can be reduced, since, particularly in the event of an impact, only the first accumulator protection element and/or the second accumulator protection element is damaged, meaning that only the first accumulator protection element and/or the second accumulator protection element needs to be replaced and, particularly advantageously, not the working device housing. This has the advantage of improving the strength of the working device housing, since the working device housing does not have to be weakened by a hole for a screw connection. Preferably, the connection, in particular between the first accumulator protection element and the second accumulator protection element, is designed as a screw connection, which is implemented as a screw-in or push-through connection. It is also conceivable that the connection is designed as a snap-fit connection, which can be opened and/or closed without tools. It is conceivable that the accumulator protection unit has, in addition to or instead of the connection between the first accumulator protection element and the second accumulator protection element, at least one connection, in particular a screw connection, between the accumulator protection unit and the working device housing.

It is also proposed that the accumulator protection unit be connected to the working device housing exclusively by means of a form-fitting connection. Advantageously, power transmission from the accumulator protection unit to the working device housing can be improved, since in particular the form closure is designed in such a way that it distributes the impact force over as large a surface as possible. The positive connection is preferably designed to prevent relative rotational movement of the accumulator protection unit relative to the working device housing, at least to a large extent. The positive connection is preferably designed to prevent relative movement of the accumulator protection unit relative to the working device housing along the most likely main impact direction, at least substantially. Preferably, the positive connection has at least one positive element on the accumulator protection unit and at least one corresponding positive element on the working device housing.

In addition, it is proposed that the accumulator protection unit be connected to the working device housing by means of a tongue and groove connection. Advantageously, the form-fit connection is particularly stable, as the circumferential and self-contained shape of the form-fit connection is particularly stable. Energy can be absorbed advantageously, as the tongue and groove in particular are designed to be elastic. Preferably, the groove is formed at least partially, preferably completely, around the working device housing or around the accumulator protection unit. Preferably, the spring is at least partially, preferably completely, formed around the working device housing or around the accumulator protection unit. Preferably, the groove and the tongue are arranged so that they are at least substantially in contact with each other. The tongue-and-groove connection is preferably designed to absorb mechanical energy, in particular impact energy.

It is also proposed that a main extension plane of a form-fitting element of the accumulator protection unit be designed to run at an angle relative to an expected main impact direction in order to create the tongue and groove connection. The advantage is that the force direction induced by the impact can be transferred particularly well into the working device housing, since the force is applied at least partially in the circumferential direction from the groove into the spring. It is advantageous to increase the breaking force, since the surface of the groove and/or the tongue on which the impact force acts can be enlarged. In particular, the smallest angle between the main impact direction and the main extension direction of the shape-locking element of the accumulator protection unit in the mounted state is greater than 45°, advantageously greater than 60°, preferably greater than 75° and particularly preferably approximately 80°. In particular, the smallest angle between the accumulator mounting direction and the main direction of the accumulator protection unit's form-fitting element is less than 45°, preferably less than 30°, more preferably less than 15%, and most preferably approximately 10°. In particular, the smallest angle between a main extension plane of an accumulator mounting opening intended for mounting the accumulator and the main extension direction of the form-fitting element of the accumulator protection unit is greater than 45°, advantageously greater than 60°, preferably greater than 75° and particularly preferably approximately 80°. Preferably, the form-fitting element extends around the working device housing, in particular circumferentially and closed in itself, wherein the form-fitting element has at least two, in particular several different, angles around the circumference relative to the main impact direction and/or to the accumulator mounting direction and/or to the main extension direction from the accumulator mounting opening. Preferably, the smallest angle from the main extension plane of the form-locking element to the main impact direction is intended to deflect a force acting in the main impact direction in the circumferential direction, thereby increasing the breaking force. The term “oblique” refers in particular to an alignment of the form-locking element relative to the main direction of impact, which is different from a parallel alignment and different from a perpendicular alignment.

Furthermore, it is proposed that the positive locking element of the accumulator protection unit is formed around the accumulator protection unit and/or that a corresponding positive locking element of the working device housing is formed around the working device housing. The form-fitting connection is particularly stable, as the surrounding and self-contained design of the form-fitting connection is especially stable. Preferably, the form-fitting element of the accumulator protection unit is designed to surround the accumulator protection unit and be self-contained. Preferably, the corresponding form-fitting element of the working device housing is designed to surround the working device housing and be self-contained. Preferably, the positive locking element arranged on the accumulator protection unit is designed as a groove. It is conceivable that the positive locking element located on the accumulator protection unit is designed as a spring. Preferably, the positive locking element arranged on the working device housing is designed as a spring. It is conceivable that the form-fitting element arranged on the working device housing is designed as a spring.

It is also proposed that the form-fitting element of the accumulator protection unit and/or a corresponding form-fitting element of the working device housing has a tapered contour. The load on the spring is advantageously reduced, since the surface, in particular the shear surface, is increased and the stiffness, in particular the bending stiffness, of the spring is increased. Preferably, the tapered contour is designed such that the thickness of the spring is smallest on the side facing the component that is arranged on the corresponding form-fitting element. Preferably, the tapered contour is designed such that the thickness of the groove is greatest on the side facing away from the component that is arranged on the corresponding form-locking element.

It is also suggested that the accumulator protection unit be interlocked with the working device housing. Impact energy can be absorbed particularly well, as the interlocking teeth need to be easily deformed in order to lock together, with the deformation absorbing the energy. Preferably, the toothing of the accumulator protection unit has at least one tooth, in particular a trapezoidal tooth, and the toothing of the working device housing has at least one corresponding tooth recess, in particular a trapezoidal tooth recess. Preferably, each tooth has a pronounced plateau and each tooth recess has a pronounced corresponding tooth base. Preferably, the interlocking arrangement is located exclusively on the two opposite sides, which are arranged parallel to the accumulator protection jaws. However, it is conceivable that the interlocking arrangement extends over the entire circumference of the accumulator protection unit and/or the working device housing. The accumulator protection unit can also be fixed to the working device housing with screw connections. In the exemplary embodiment with interlocking, the screw connections, in particular screw domes, are arranged parallel to the most probable main impact direction. Preferably, each screw connection has a screw dome. Preferably, an elastic damping element is arranged in each screw dome, which is designed in particular as a rubber spacer sleeve. The elastic damping element is preferably designed to dampen impact loads and prevent mechanical stress on the screw connection, especially when locked. A “screw dome” refers in particular to an essentially cylindrical or conical projection into which the screw used to establish the connection can be screwed. For example, screw domes have holes into which the screws are screwed. The screw domes can be used, for example, to provide the necessary minimum length for the screw connection without having to equip the entire component with the corresponding wall thickness. This makes it possible, in particular, to arrange a damping element and/or a clamping element and/or a form-locking element and/or a screw-locking element or the like in the screw dome.

In addition, it is proposed that an interlock between the accumulator protection unit and the working device housing forms an energy absorption unit which is designed to absorb at least part of the energy from an impact. One advantage is increased strength, as some of the impact energy can be absorbed, thereby reducing the load on the component. Preferably, the teeth of the gearing on the accumulator protection unit are spaced apart from the corresponding tooth recess on the working device housing when unloaded. Preferably, the gearing of the accumulator protection unit is arranged in an unloaded state so that it does not come into contact with the corresponding tooth recess of the working device housing. Preferably, a front surface of each tooth of the accumulator protection unit, especially in each operating state other than a block state, is spaced further apart from a corresponding base surface of the working device housing of each tooth base than a tooth flank of each tooth is spaced apart from a corresponding tooth surface of each tooth base. The energy absorption unit preferably forms a damping cascade. Preferably, the damping cascade is formed at least from the damping elements of each of the screw domes and the interlocking teeth. Preferably, the sequence of the damping cascade is defined by the distances between the block states of the interlocking and the screw connection. The damping element is preferably arranged in the damping cascade upstream of the gearing. Any alternative sequence in the damping cascade, in particular a damping cascade with additional damping elements, is conceivable. An “operating state” should preferably be understood as a state in which the protective device is ready for operation in the event of an impact load and/or is in an unloaded state in which an accumulator can be protected, in particular before an impact, and/or impact energy can be absorbed.

It is also proposed that the accumulator protection unit comprises at least one flexible, elastic energy absorption element which is molded onto or fastened to an accumulator protection element of the accumulator protection unit. One advantage is increased strength, as some of the impact energy can be absorbed, thereby reducing the load on the component. Preferably, at least one flexible elastic energy absorption element is arranged on a side of the accumulator protection unit facing away from the working device housing. The elastic energy absorption element is preferably made from a thermoplastic elastomer, in particular using an injection molding method, which has pronounced elastic material properties. Preferably, at least one flexible, elastic energy absorption element is connected to the accumulator protection unit in a material-locking manner.

It is further proposed that at least one accumulator protection jaw of one of the accumulator protection elements extends over at least a large part of one side of the accumulator protection jaw and comprises a damping and/or stiffening structure formed integrally, preferably monolithically, on the accumulator protection element. Resistance to damage can be improved, as the accumulator protection element with the stiffening structure can withstand greater impact forces and the accumulator protection element with the damping structure absorbs more impact energy. Preferably, the molded damping and/or stiffening structure is arranged on one side, in particular on an inner side, of the first accumulator protection jaw and the second accumulator protection jaw. Preferably, the damping and/or stiffening structure has a honeycomb structure, in particular a hexagonal and/or six-sided honeycomb structure. It is also conceivable that the damping and/or stiffening structure is designed as a rib-shaped, in particular molded, structure. The damping and/or stiffening structure is preferably made of the same material as the accumulator protection jaws. It is conceivable that the damping and/or stiffening structure is made of a different material, in particular one that is more elastically flexible, such as the accumulator protection jaws. The term “one-piece” is understood to mean, in particular, at least connected by a material bond, for example by a welding process, an adhesive bonding process, an injection molding process, and/or another process that appears reasonable to a person skilled in the art, and/or advantageously formed in one piece, such as by manufacturing from a casting and/or by manufacturing in a single-component or multi-component injection molding process and advantageously from a single blank.

Furthermore, an accumulator mounting unit is proposed, which at least forms the accumulator mounting region for mounting the accumulator on the working device, wherein the accumulator mounting unit is designed such that the accumulator can only be mounted when an accumulator protection element is installed, in particular correctly. Safety can be increased, as it is not possible to operate the working device without the accumulator protection unit. The accumulator mounting unit is preferably designed to at least enable and/or simplify the mounting and/or dismounting of the accumulator in one mounting direction.

In addition, it is proposed that at least one accumulator mounting element of the accumulator mounting unit is connected to the accumulator protection element in one piece or monolithically. Safety can be increased, as it is not possible to operate the working device without the accumulator protection unit. Mounting can be simplified, since the accumulator mounting element, which is connected to the accumulator protection element in one piece or monolithically, is automatically attached and/or positioned when the accumulator protection elements are mounted on the working device housing and does not have to be mounted separately and, particularly advantageously, does not have to be centered and/or aligned.

It is also proposed that the accumulator mounting element forms at least part of a guide rail for guiding the insertion or removal movement of the accumulator. Safety can be increased, as it is not possible to operate the working device without the accumulator protection unit. The accumulator mounting unit is preferably designed as at least one guide rail, in particular as an accumulator rail. Preferably, the guide rail guides an accumulator mounting and/or limits accumulator movement during and/or after mounting at least substantially perpendicular to a mounting direction.

Furthermore, it is proposed that the accumulator mounting unit is at least largely, preferably completely, formed by the accumulator protection unit, which can be connected to the working device housing in a manner that can be separated without damage. This has the advantage of increasing safety, since the accumulator in particular cannot be mounted and/or operated without the accumulator protection unit. The accumulator mounting unit is preferably connected to the accumulator protection unit in one piece. Preferably, the accumulator mounting unit is formed from each of the at least two accumulator protection elements of the accumulator protection unit. In this context, “a large part” could mean, for example, with the exception of an electrical connection element, in particular contact conductors. It is conceivable that the electrical accumulator interface, in particular the contact conductors, is integrated into the accumulator protection unit and connected to the working device via a plug connection. Alternatively, it is also conceivable that at least one electrical contact is integrated into the accumulator protection unit from the electrical accumulator interface and/or is inserted through the accumulator protection unit.

Furthermore, an accumulator protection element is proposed for forming a protective device, in particular an impact protection device. One advantage is that service life can be extended, as the accumulator is no longer damaged in the event of an impact with a solid object, such as if the working device falls. The accumulator protection element can be conveniently replaced by the user. Preferably, one of the at least two accumulator protection elements and/or individual accumulator protection elements and/or all accumulator protection elements are designed separately from one another and/or can be mounted separately and/or are available as spare parts and, in particular, can be changed and/or replaced by the operator himself.

Furthermore, a portable working device, such as a handheld power tool, a portable gardening tool, a portable household appliance, and/or the like, is proposed with the protective device. The service life of the portable working device can be extended, as dropping the working device does not damage the accumulator. It is advantageous to extend the maintenance interval, as the accumulator in particular will no longer be damaged in the event of an impact with a solid object, such as a fall.

In addition, a method is proposed for at least protecting an accumulator of a portable working device, for example a handheld power tool, a portable gardening tool, a portable household appliance and/or the like, in particular by means of a protective device with at least one accumulator protection unit designed differently from a working device housing, wherein the accumulator is protected against impact damage, for example due to an impact resulting from the working device falling, by at least partially shielding at least the sides of an accumulator mounting region of the working device by means of the accumulator protection unit. The service life of the portable working device can be extended, as dropping the working device does not damage the accumulator. It is advantageous that the maintenance interval can be extended, as the accumulator in particular is no longer damaged in the event of an impact with a solid object, such as a fall.

The protective device, accumulator protection element, portable working device, and method according to the invention, at least for protecting an accumulator, should not be limited to the application and embodiment described above. In particular, the protective device according to the invention, the accumulator protection element according to the invention, the portable working device according to the invention, and the method according to the invention may comprise, at least for the purpose of protecting an accumulator and fulfilling a function described herein, a number of individual elements, components, and units as well as process steps that differs from the number specified herein. Furthermore, values within the ranges specified in this disclosure shall also be considered disclosed and freely usable.

### DRAWINGS

Further advantages follow from the description of the drawings below. Two exemplary embodiments of the invention are shown in the drawings. The drawings, the description, and the claims contain numerous features in combination. A person skilled in the art will appropriately also consider the features individually and combine them into additional advantageous combinations.

The figures show:

FIG. 1 is a schematic representation of a working device according to the invention with a protective device,

FIG. 2 is a schematic representation of the working device with the protective device.

FIG. 3a is a schematic representation of the protective device with an accumulator protection unit comprising an accumulator protection element,

FIG. 3b is a schematic representation of the protective device with an accumulator protection unit featuring an alternative accumulator protection element.

FIG. 4 is a schematic flow chart of a method for protecting an accumulator,

FIG. 5 is a schematic representation of an alternative embodiment of a working device with an alternative protective device,

FIG. 6 is a schematic representation of an energy absorption unit of the alternative protective device and

FIG. 7 is a schematic flow chart of an alternative method for protecting an accumulator.

### DESCRIPTION OF THE EXEMPLARY EMBODIMENTS

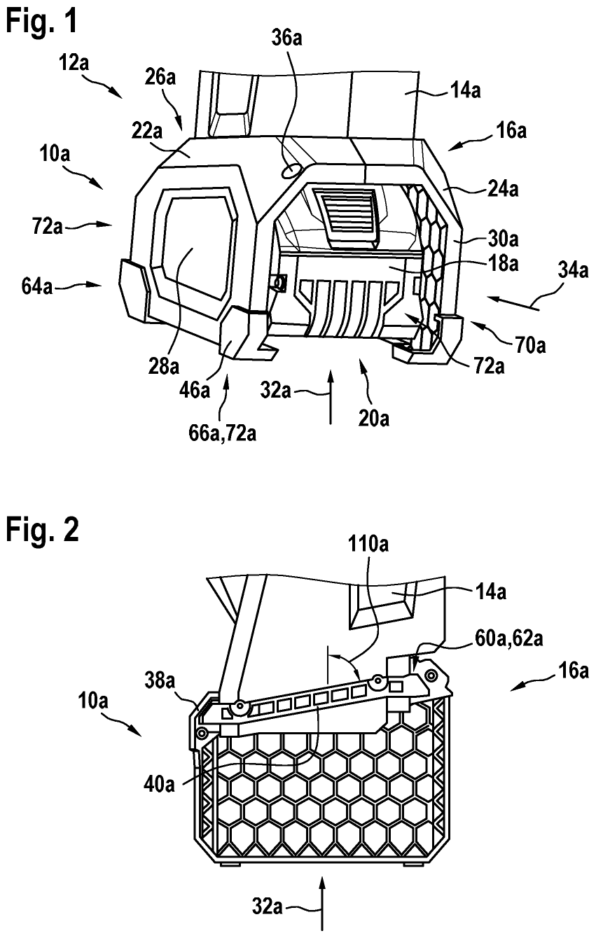

FIG. 1 shows part of a portable working device 12a. The portable working device 12a is designed as a portable handheld power tool. Alternatively, the working device 12a could also be designed as a portable gardening tool or a portable household appliance or a portable hygiene device or the like. The portable working device 12a has an accumulator 18a. The portable working device 12a has a protective device 10a. The protective device 10a is designed as an impact protection device. The protective device 10a is intended for mounting on the portable working device 12a. The protective device 10a has an accumulator protection unit 16a. The accumulator protection unit 16a is designed differently from a working device housing 14a. The accumulator protection unit 16a is designed to protect the accumulator 18a of the working device 12a from damage. The damage to the accumulator 18a could be the result of impact damage. The impact damage could have been caused by an impact resulting from the working device 12a falling. The accumulator protection unit 16a protects the accumulator 18a by surrounding an accumulator mounting region 20a laterally. The accumulator protection unit 16a provides additional protection for the accumulator 18a against scratching. The accumulator protection unit 16a provides additional protection for the accumulator 18a against contamination from dust and dirty water. The accumulator protection unit 16a protects the working device housing 14a from impact damage.

The accumulator protection unit 16a has a first accumulator protection element 22a. The accumulator protection unit 16a has a second accumulator protection element 24a. The second accumulator protection element 24a is separate from the first accumulator protection element 22a. The accumulator protection elements 22a, 24a are made of impact-resistant and/or energy-absorbing material. The material of the accumulator protection elements 22a, 24a has more flexible material properties than the material of the working device housing 14a. Alternatively, the accumulator protection elements 22a, 24a could be made of the same material as the working device housing 14a. The accumulator protection unit 16a has a connection region 26a. In the connecting region 26a, the accumulator protection unit 16a is connected to the working device 12a. The accumulator protection unit 16a completely surrounds the working device housing 14a. Alternatively, the accumulator protection unit 16a could only partially surround the working device housing 14a. The first accumulator protection element 22a and the second accumulator protection element 24a are connected to each other by two detachable connecting elements 36a. The connecting element 36a is designed as a screw. The connecting elements 36a are completely recessed in the first accumulator protection element 22a and in the second accumulator protection element 24a. The connecting elements 36a are arranged parallel to the working device housing 14a. The accumulator protection unit 16a is connected to the working device housing 14a without any screw connections. The accumulator protection unit 16a is connected to the working device housing 14a in a non-destructive manner. Alternatively, the accumulator protection elements 22a, 24a could, for example, be connected and/or screwed in a close proximity to the tongue and groove connection with the working device housing 14a.

The first accumulator protection element 22a forms a first accumulator protection jaw 28a. The first accumulator protection pad 28a covers the entire surface. The second accumulator protection element 24a forms a second accumulator protection jaw 30a. The second accumulator protection pad 30a covers the entire surface. Alternatively, only the first accumulator protection jaw 28a or only the second accumulator protection jaw 30a could be designed to cover the entire surface. Alternatively, the first accumulator protection jaw 28a and/or the second accumulator protection jaw 30a could be formed over a large part of their surface. It is conceivable that the first accumulator protection plate 28a and/or the second accumulator protection plate 30a have perforations, such as holes and/or slots. The first accumulator protection jaw 28a and the second accumulator protection jaw 30a are designed to be mirror images of each other. The first accumulator protection jaw 28a and the second accumulator protection jaw 30a are arranged on opposite sides of the accumulator 18a. The first accumulator protection jaw 28a and the second accumulator protection jaw 30a are arranged parallel to one longitudinal side of the accumulator 18a. The first accumulator protection jaw 28a and the second accumulator protection jaw 30a are arranged so that they do not come into contact with the accumulator 18a. The first accumulator protection jaw 28a and the second accumulator protection jaw 30a are positioned in the main direction of impact above the mounted accumulator 18a. The first accumulator protection jaw 28a and the second accumulator protection jaw 30a are parallel to the longitudinal direction above the mounted accumulator 18a. The accumulator protection jaws 28a, 30a are connected to each other via the accumulator protection elements 22a, 24a and/or via the connecting elements 36a. The accumulator protection jaws 28a, 30a are free of additional connecting elements and/or webs.

The first accumulator protection jaw 28a has a main extension plane. The main extension plane of the first accumulator protection jaw 28a is aligned parallel to a most probable main impact direction 32a. The main extension plane of the first accumulator protection jaw 28a is aligned parallel to an accumulator mounting direction 34a. The second accumulator protection jaw 30a has a main extension plane. The main extension plane of the second accumulator protection jaw 30a is aligned parallel to a most probable main impact direction 32a. The main extension plane of the second accumulator protection jaw 30a is aligned parallel to the accumulator mounting direction 34a. The main direction of extension of the first accumulator protection jaw 28a is parallel to the main direction of extension of the second accumulator protection jaw 30a. The accumulator protection unit 16a has an accumulator mounting opening 70a. The accumulator mounting opening 70a extends perpendicular to the accumulator mounting direction 34a. The accumulator mounting opening 70a is designed to allow the accumulator 18a to be mounted and/or dismounted when the accumulator protection unit 16a is mounted. It is conceivable that the accumulator protection unit 16a has further openings 72a, such as on the side of the accumulator 18a facing away from the working device housing 14a and/or on the side of the accumulator 18a facing away from the accumulator mounting opening 70a. It is conceivable that the further openings 72a of the accumulator protection unit 16a extend only partially over the side surfaces of the accumulator protection unit 16a assigned to the opening.

The accumulator protection unit 16a has four flexible elastic energy absorption elements 46a. The accumulator protection unit 16a could also have a number of flexible elastic energy absorption elements 46a that differs from 4. The flexible elastic energy absorption elements 46a are molded onto or attached to the accumulator protection element 22a, 24a of the accumulator protection unit 16a. The energy absorption elements 46a are molded onto the accumulator protection elements 22a, 24a in a multi-component injection molding method. Each of the four energy absorption elements 46a has a material thickness of at least 4 mm. The accumulator protection unit 16a has four corners 64a. The corners 64a are arranged on a side 66a of the accumulator protection unit 16a facing away from the working device housing 14a. A flexible elastic energy absorption element 46a is molded or attached to each of the corners 64a. The flexible elastic energy absorption elements 46a are made of a thermoplastic elastomer. The flexible, elastic energy absorption elements 46a have a pronounced elastic material property. The energy absorption elements 46a are designed to absorb some of the impact energy.

FIG. 2 shows the protective device 10a in a side view. The accumulator protection unit 16a is connected to the working device housing 14a by means of a form fit 60a. The accumulator protection unit 16a is connected to the working device housing 14a by means of a tongue and groove connection 62a. The accumulator protection unit 16a has a form-fitting element 38a. When mounted, the form-fitting element 38a of the accumulator protection unit 16a points toward the working device housing 14a. The form-fitting element 38a of the accumulator protection unit 16a for producing the tongue and groove connection 62a has a main extension plane. The main extension plane is designed to run at an angle relative to the expected main impact direction 32a.

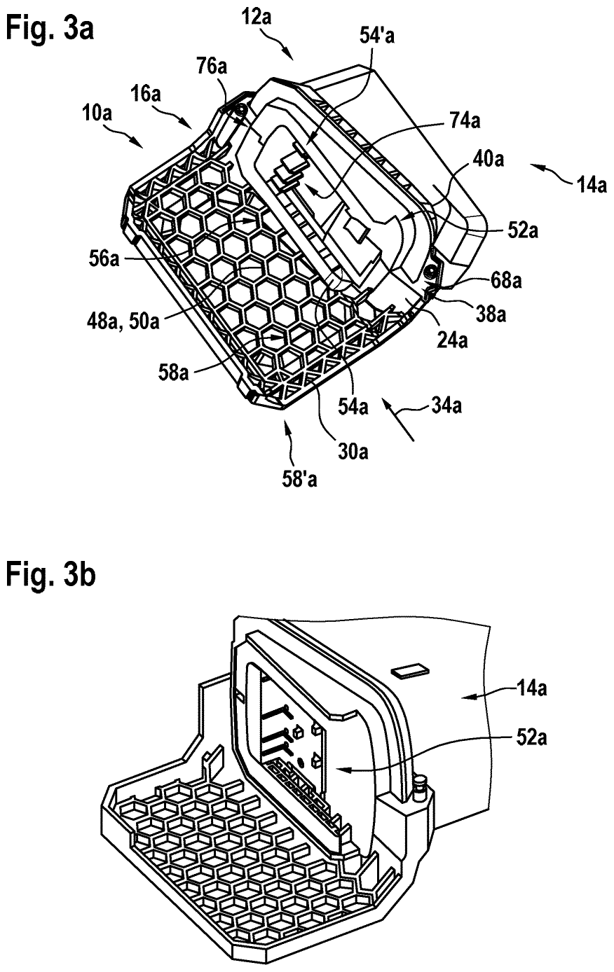

FIG. 3a shows a representation of the working device 12a with the accumulator protection element 24a. The form-fitting element 38a of the accumulator protection unit 16a is formed around the accumulator protection unit 16a. The form-fitting element 38a is formed by the first accumulator protection element (not shown) and the second accumulator protection element 24a. The first accumulator protection element (not shown) and the second accumulator protection element 24a are arranged relative to each other in the mounted state such that the form-locking element 38a is formed seamlessly around the circumference and endlessly. The working device housing 14a has a positive locking element 40a corresponding to the positive locking element 38a. The corresponding positive locking element 40a of the working device housing 14a is formed around the working device housing 14a. The form-fitting element 38a of the accumulator protection unit 16a has a tapered contour 68a. The corresponding positive locking element 40a of the working device housing 14a has a tapered contour. The form-locking element 38a is tapered in the direction of the corresponding form-locking element 40a. The corresponding positive locking element 40a is tapered in the direction of the positive locking element 38a. A side of the positive locking element 38a and the corresponding positive locking element 40a facing the accumulator 18a is aligned parallel to the accumulator mounting direction 34a. A side of the positive locking element 38a and the corresponding positive locking element 40a facing away from the accumulator 18a forms an angle with the accumulator mounting direction 34a.

The accumulator protection jaws 28a, 30a of the accumulator protection elements 22a, 24a extend flat over a large part of one jaw side 58a of the accumulator protection jaw 28a, 30a. The accumulator protection jaw 28a, 30a comprises a damping structure 48a. The damping structure 48a is integrally or monolithically molded onto the accumulator protection element 22a, 24a. The damping structure 48a is arranged on a jaw side 58a facing the accumulator 18a. Alternatively, the damping structure 48a could be arranged on a jaw side 58′a facing away from the accumulator 18a or on both jaw sides 58a, 58′a. The accumulator protection jaw 28a, 30a comprises a stiffening structure 50a. The stiffening structure 50a is integrally or monolithically molded onto the accumulator protection element 22a, 24a. The stiffening structure 50a is arranged on a jaw side 58a facing the accumulator 18a. Alternatively, the stiffening structure 50a could be arranged on a jaw side 58′a facing away from the accumulator 18a or on both jaw sides 58a, 58′a. The damping structure 48a and the stiffening structure 50a are made of the same material as the accumulator protection jaws 28a, 30a. Alternatively, the damping structure 48a and/or the stiffening structure 50a could be made of a different material, such as the accumulator protection jaws 28a, 30a.

The protective device 10a has an accumulator mounting unit 52a. The accumulator mounting unit 52a forms the accumulator mounting region 20a for mounting the accumulator 18a on the working device 12a. The accumulator mounting unit 52a is designed such that the accumulator 18a can only be mounted when an accumulator protection element 22a, 24a is properly installed. The accumulator mounting unit 52a has two accumulator mounting elements 54a, 54′a. The accumulator mounting element 54a, 54′a of the accumulator mounting unit 52a is connected in one piece or monolithically to the accumulator protection element 22a, 24a. The accumulator mounting element 54a, 54′a forms part of a guide rail 56a. Alternatively, the accumulator mounting unit 52a could be formed completely or partially by the working device housing 14a (see FIG. 3b). The guide rail 56a is designed to guide the insertion or removal movement of the accumulator 18a. The guide rail 56a is aligned parallel to the accumulator mounting direction 34a. The guide rail 56a is provided for fixing the accumulator 18a perpendicular to the accumulator mounting direction 34a. The guide rail 56a has an entry bevel in the accumulator mounting direction 34a. The import slope is designed to simplify accumulator mounting. The accumulator mounting unit 52a is largely formed by the accumulator protection unit 16a, which can be connected to the working device housing 14a in a manner that can be released without damage. Alternatively, the accumulator mounting unit 52a could be formed entirely by the accumulator protection unit 16a, which can be connected to the working device housing 14a in a manner that can be separated without damage. The accumulator mounting unit 52a is designed to position the accumulator 18a relative to an electrical connection element 74a of the working device 12a. The accumulator mounting unit 52a is designed to connect the accumulator 18a to an electrical connection element 74a of the working device 12a. The accumulator mounting unit 52a has a closure element 76a. The closure element 76a is designed to fix the accumulator 18a in the accumulator mounting region 20a in a form-fitting manner. Alternatively, the closure element 76a could be arranged on the working device housing 14a. The closure element 76a is designed as a snap-in recess. The snap-in recess is designed to create a positive connection with a corresponding snap-in element.

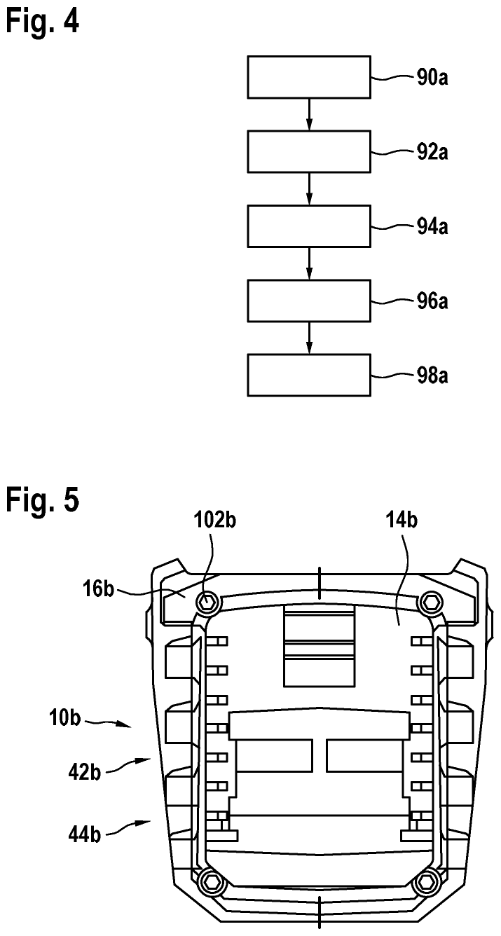

FIG. 4 shows a schematic flowchart of a method for protecting an accumulator 18a of a portable working device 12a, such as a handheld power tool, a portable gardening tool, a portable household appliance, and/or the like, by means of a protective device 10a.

In a method step 90a, an accumulator 18a is protected from impact loads by an accumulator protection unit 16a that is separate from a working device housing 14a. The accumulator 18a is protected from impact loads and/or impact damage by partial lateral shielding of an accumulator mounting region 20a of the working device 12a by the accumulator protection unit 16a. The accumulator 18a is protected against impact damage, for example, by an impact resulting from the working device 12a falling and/or by the working device 12a hitting a wall.

In a further method step 92a, the working device housing 14a is protected from impact by the accumulator protection unit 16a. The working device housing 14a is protected against impact damage by the accumulator protection unit 16a being designed in such a way that it is destroyed by a mechanical impact load before the working device housing is damaged.

In a further method step 94a, the working device 12a and/or the accumulator 18a are protected during the impact load by four energy absorption elements 46a, which absorb the impact energy during the impact.

In a further method step 96a, the working device 12a and/or the accumulator 18a are protected during the impact load by a damping structure 48a arranged on each inner jaw side 58a, which absorbs impact energy during the impact.

In a further method step 98a, the accumulator 18a is additionally protected against contamination and/or dirty water.

FIGS. 5 through 7 show another exemplary embodiment of the invention. The following descriptions and the drawings are substantially limited to the differences between the exemplary embodiments, wherein reference can, in principle, also be made, with respect to identically designated components, in particular with respect to components having the same reference numbers, to the drawings and/or the description of the other exemplary embodiments, in particular FIGS. 1 through 4. In order to distinguish the exemplary embodiments, the letter a is appended to the reference numbers of the exemplary embodiment in FIGS. 1 through 4. In the exemplary embodiment shown in FIGS. 5 through 7, the letter a is replaced by the letter b.

FIG. 5 shows a schematic representation of a protective device 10b in a view from below. The protective device 10b has an accumulator protection unit 16b. The accumulator protection unit 16b has a gearing 42b with the working device housing 14b. The gearing 42b between the accumulator protection unit 16b and the working device housing 14b forms an energy absorption unit 44b. The energy absorption unit 44b is designed to absorb at least part of the energy from an impact. The accumulator protection unit 16b is screwed to the working device housing 14b using four screws 102b.

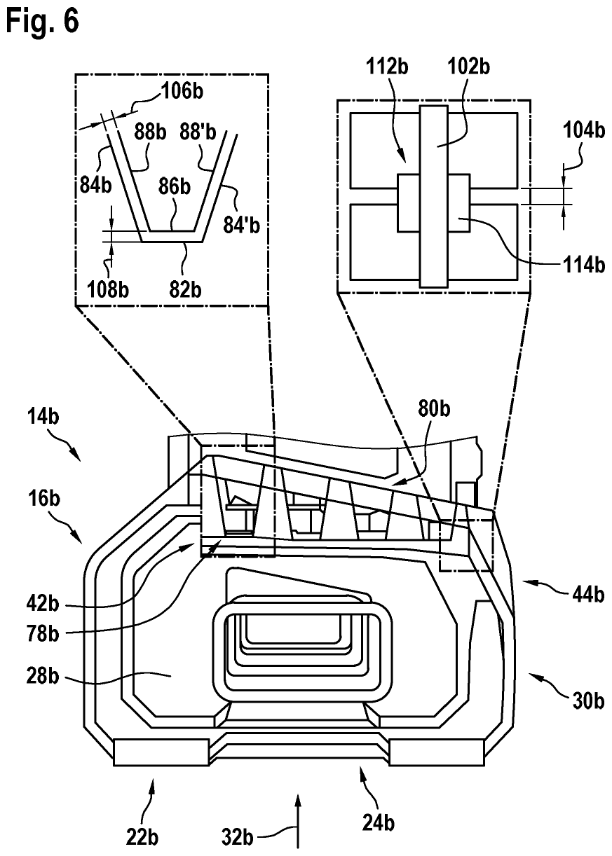

FIG. 6 shows a schematic representation of the gearing 42b in a side view. The gearing 42b has trapezoidal teeth 78b on the accumulator protection unit 16b. The gearing 42b has trapezoidal tooth recesses 80b on the working device housing 14b that correspond to the trapezoidal teeth 78b of the accumulator protection unit 16b. Each tooth 78b has a pronounced plateau-shaped base surface 82b. Each tooth recess 80b has a pronounced corresponding tooth base surface 86b. The gearing 42b is arranged on two sides parallel to the accumulator protection jaws 28b, 30b. Alternatively, the gearing 42b could also be arranged circumferentially between the accumulator protection unit 16b and the working device housing 14b. The teeth 78b and the tooth recess 80b of the gearing 42b are arranged perpendicular to the main impact direction next to each other, wherein the gearing 42b is designed to absorb a force in the main impact direction. Alternatively, teeth 78b and tooth recess 80b of gearing 42b could be arranged parallel to the main impact direction, one next to the other, wherein the alternative arrangement of gearing 42b could be designed to absorb a force perpendicular to the main impact direction.

The first accumulator protection element 22b is attached to the working device housing 14b with two screws 102b. The second accumulator protection element 24b is attached to the working device housing 14b with two screws 102b. Each screw 102b is arranged parallel to the most probable main impact direction 32b. Each screw 102b has a screw dome 112b. A damping element 114b is arranged in each screw dome 112b. The damping element 114b is designed as a rubber spacer sleeve. The rubber spacer sleeve is made of an elastic material such as rubber or elastomer. Alternatively, the damping element 114b could also be designed as a metallic spring element. It is also conceivable that the damping element 114b is designed as a shape memory alloy. The damping element 114b is designed to dampen impact loads. The screw dome 112b is designed to prevent blockage and thus impact loads on the screw connection. The energy absorption unit 44b forms a damping cascade. The damping cascade consists of the damping elements 114b of the screw 102b and the gearing 42b. The damping elements 114b are arranged in the damping cascade in front of the gearing 42b.

The teeth 78b and the corresponding tooth recess 80b are spaced apart from each other in an unloaded state. The teeth 78b and the corresponding tooth recess 80b are arranged so that they do not come into contact with each other when unloaded. The teeth 78b each have two tooth flanks 84b, 84′b. The corresponding tooth recess 80b has tooth base flanks 88b, 88′b corresponding to the tooth flanks 84b, 84′b. In each state other than a block state, the gearing 42b between the base surface 82b and the corresponding tooth base surface 86b has a shortest distance 108b which is greater than the shortest distance 106b between each of the two tooth flanks 84b, 84′b and the corresponding tooth base flank 88b, 88′b. The accumulator protection unit 16b and the working device housing 14b have a shortest distance 104b in a region of the screw dome 112b. The shortest distance 104b is greater than the shortest distance 108b. The shortest distance 104b is greater than the shortest distance 106b.

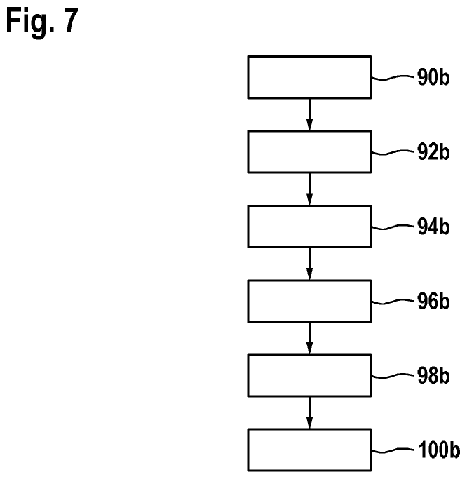

FIG. 7 shows a schematic flowchart of a method for protecting an accumulator 18b of a portable working device 12b, such as a handheld power tool, a portable gardening tool, a portable household appliance, and/or the like, by means of a protective device 10b.

In a method step 90b, an accumulator 18b is protected from impact loads by an accumulator protection unit 16b that is separate from a working device housing 14b. The accumulator 18b is protected against impact damage by partial lateral shielding of an accumulator mounting region 20b of the working device 12b by the accumulator protection unit 16b. The accumulator 18b is protected against impact damage, for example, due to an impact resulting from the working device 12b falling and/or the working device 12b hitting a wall.

In a further method step 92b, the working device housing 14b is protected from impact by the accumulator protection unit 16b. The working device housing 14b is protected against impact damage by the accumulator protection unit 16b being designed in such a way that it is destroyed by a mechanical impact load before the working device housing 14b is damaged.

In a further method step 94b, the working device 12b and/or the accumulator 18b are protected during the impact load by four energy absorption elements 46b, which absorb the impact energy during the impact.

In a further method step 96b, the working device 12b and/or the accumulator 18b are protected during the impact load by a damping structure 48b arranged on each inner jaw side 58b, which absorbs impact energy during the impact.

In a further method step 98b, the accumulator 18b is additionally protected against contamination and/or dirty water.

In a further method step 100b, the working device 12b and/or the accumulator 18b are protected during the impact load by an energy absorption unit 44b, which absorbs impact energy during the impact. The energy absorption unit 44b is formed by a damping cascade. In the damping cascade, the impact energy is first damped by the damping elements 114b in the screw connection. The impact load is damped by the damping elements 114b until the teeth 78b and the tooth recess 80b of the gearing 42b come into contact. The impact energy is then absorbed by the gearing 42b. During impact loading, the tooth flanks 84b and the corresponding tooth base flanks 88b are pressed against each other, thereby achieving energy absorption by the energy absorption unit. If the impact force is so great that the base surface 82b of the teeth 78b comes into contact with the corresponding tooth base flanks 88b, then a blocking state is reached. In the block state, no further elastic and/or plastic material deformation or impact energy is absorbed.

1.-23. (canceled)

24. An impact protection device for a portable working device, comprising:
at least one accumulator protection unit different from a working device housing of the portable working device, the at least one accumulator protection unit configured to protect at least one accumulator of the portable working device from impact damage by at least partially surrounding an accumulator mounting region of the portable working device at least on one side.

25. The impact protection device according to claim 24, wherein:
the at least one accumulator protection unit includes a first accumulator protection element and a second accumulator protection element, and
the first accumulator protection element and the second accumulator protection element surround the working device housing completely, at least in a connection region of the at least one accumulator protection unit, in which the at least one accumulator protection unit is connected to the portable working device.

26. The impact protection device according to claim 24, wherein:
the at least one accumulator protection unit comprises at least one first accumulator protection element and at least one second accumulator protection element, and
the at least one second accumulator protection element is formed separately from the at least one first accumulator protection element.

27. The impact protection device according to claim 26, wherein the at least one first accumulator protection element forms at least one, full-surface, first accumulator protection jaw and/or the at least one second accumulator protection element forms a second accumulator protection jaw, covering an entire surface, and/or the at least one first accumulator protection jaw and/or the at least one second accumulator protection jaw has a main extension plane which is at least substantially parallel to a most probable main impact direction and/or at least substantially perpendicular to an accumulator mounting direction and/or at least one accumulator protection jaw of one of the at least one first and second accumulator protection elements has a damping structure and/or a stiffening structure extending over at least a part of one side of the accumulator protection jaw and formed monolithically on the one accumulator protection element.

28. The impact protection device according to claim 25, wherein the first accumulator protection element and the second accumulator protection element are connected to each other by at least one detachable connecting element.

29. The impact protection device according to claim 24, wherein:
the at least one accumulator protection unit is connected to the working device housing free of screw connections to the working device housing,
the at least one accumulator protection unit is non-destructively detachable from the working device housing,
the at least one accumulator protection unit is connected to the working device housing with a positive fit, and/or
the at least one accumulator protection unit is interlocked with the working device housing.

30. The impact protection device according to claim 24, wherein:
the at least one accumulator protection unit is connected to the working device housing with a tongue and groove connection,
a main extension plane of a form-locking element of the at least one accumulator protection unit is configured to run obliquely relative to an expected main impact direction to produce the tongue and groove connection, and
(i) the form-locking element of the at least one accumulator protection unit is configured to run circumferentially around the at least one accumulator protection unit, (ii) a corresponding form-locking element of the working device housing is configured to run circumferentially around the working device housing, and/or (iii) the form-locking element of the at least one accumulator protection unit and/or a corresponding form-locking element of the working device housing has a tapered contour.

31. The impact protection device according to claim 30, wherein a gearing between the at least one accumulator protection unit and the working device housing forms an energy absorption unit configured to absorb at least part of an energy from an impact.

32. The impact protection device according to claim 24, wherein:
the at least one accumulator protection unit includes at least one flexible elastic energy absorption element, and
the at least one flexible elastic energy absorption element molded onto or fastened to an accumulator protection element of the at least one accumulator protection unit.

33. The impact protection device according to claim 24, wherein:
an accumulator mounting unit forms the accumulator mounting region for mounting the at least one accumulator on the working device, and
the accumulator mounting unit is configured such that mounting of the at least one accumulator is only possible when an accumulator protection element is installed correctly.

34. The impact protection device according to claim 33, wherein at least one accumulator mounting element of the accumulator mounting unit is connected integrally or monolithically to the accumulator protection element.

35. The impact protection device according to claim 34, wherein the at least one accumulator mounting element is configured to form at least part of a guide rail configured to guide an insertion or removal movement of the at least one accumulator.

36. The impact protection device according to claim 33, wherein the accumulator mounting unit is formed completely by the at least one accumulator protection unit, which is configured for connection to the working device housing in a manner which can be released without destruction.

37. The impact protection device according to claim 24, wherein the impact damage is due to an impact resulting from the portable working device falling.

38. A portable working device, comprising:
the impact protection device according to claim 24.

39. A method for at least protecting an accumulator of a portable working device using a protective device according to claim 24, with at least one accumulator protection unit that is different from a working device housing of the portable working device, the method comprising:
protecting the accumulator by at least partial, at least lateral shielding of an accumulator mounting region of the portable working device using the at least one accumulator protection unit against impact damage.
